(19) United States
(12) Patent Application Publication
(10) Pub. No.: US 2015/0263421 A1
(43) Pub. Date: Sep. 17, 2015

(54) ELECTRONIC PACKAGE AND FABRICATION METHOD THEREOF

(71) Applicant: SILICONWARE PRECISION INDUSTRIES CO., LTD., Taichung (TW)

(72) Inventors: Chih-Hsien Chiu, Taichung (TW); Tsung-Hsien Tsai, Taichung (TW); Chi-Pin Tsai, Taichung (TW); Chih-Ming Cheng, Taichung (TW)

(73) Assignee: SILICONWARE PRECISION INDUSTRIES CO., LTD., Taichung (TW)

(21) Appl. No.: 14/290,121

(22) Filed: May 29, 2014

(30) Foreign Application Priority Data
Mar. 17, 2014 (TW) 103109875

(51) Int. Cl. H01Q 1/52; H01Q 1/22; H01Q 9/04

(52) U.S. Cl. CPC H01Q 1/526; H01Q 9/0407; H01Q 1/22

(57) ABSTRACT

An electronic package is provided, which includes: a substrate; at least an electronic element disposed on the substrate; an antenna structure provided on the substrate, wherein the antenna structure has at least a supporting portion and an extending portion supported by the supporting portion over the substrate and surrounding the electronic element; and a shielding structure provided on the substrate and overlapping with the antenna structure, thereby saving the surface area of the substrate so as to meet the miniaturization requirement of the electronic package.

### BACKGROUND OF THE INVENTION

1. Field of the Invention

The present invention relates to electronic packages, and more particularly, to an electronic package having an antenna structure.

2. Description of Related Art

Along with the rapid development of electronic industries, electronic products are developed toward the trend of multi-function and high performance. Wireless communication technologies have been widely applied in various kinds of consumer electronic products for receiving or transmitting various wireless signals. To meet the miniaturization requirement of consumer electronic products, wireless communication modules are becoming lighter, thinner, shorter and smaller. For example, patch antennas have been widely applied in wireless communication modules of electronic products such as cell phones and personal digital assistants (PDAs) due to their advantages of small size, light weight and easy fabrication.

FIG. 1 is a schematic perspective view of a conventional wireless communication module. Referring to FIG. 1, the wireless communication module 1 has: a substrate 10, a plurality of electronic elements 11 disposed on and electrically connected to the substrate 10, an antenna structure 12 disposed on the substrate 10, and an encapsulant 13. The substrate 10 is a circuit board and has a rectangular shape. The antenna structure 12 is of a planar type. The antenna structure 12 has an antenna body 120 and a conductive wire 121 electrically connecting the antenna body 120 to the electronic elements 11. The encapsulant 13 encapsulates the electronic elements 11 and a portion of the conductive wire 121.

However, during the fabrication process of the wireless communication module 1, based on the characteristic of electromagnetic radiation between the planar-type antenna structure 12 and the electronic elements 11 and limitation of the size of the planar-type antenna structure 12, the antenna body 120 of the antenna structure 12 cannot be integrally fabricated with the electronic elements 11. That is, only the electronic elements 11 are covered by the encapsulant 13 while the antenna body 120 of the antenna structure 12 is exposed from the encapsulant 13. Therefore, the molding process for forming the encapsulant 13 needs to use a mold having a size corresponding to the electronic element-mounting area instead of the overall substrate 10, thus complicating the molding process.

Further, the substrate 12 needs to have an additional substrate area for receiving the antenna body 120 that is positioned outside the area where the encapsulant 13 is to be formed, thus hindering miniaturization of the wireless communication module 1.

Therefore, how to overcome the above-described drawbacks has become critical.

### SUMMARY OF THE INVENTION

In view of the above-described drawbacks, the present invention provides an electronic package, which comprises: a substrate; at least an electronic element disposed on the substrate; an antenna structure provided on the substrate, wherein the antenna structure has at least a supporting portion and an extending portion supported by the supporting portion over the substrate and surrounding the electronic element; and a shielding structure provided on the substrate and overlapping with the antenna structure.

The present invention further provides a method for fabricating an electronic package, which comprises the steps of: providing a substrate having at least an electronic element disposed thereon; and providing an antenna structure and a shielding structure on the substrate such that the shielding structure overlaps with the antenna structure, wherein the antenna structure has at least a supporting portion and an extending portion supported by the supporting portion over the substrate and surrounding the electronic element.

In the above-described method, the antenna structure can be provided on the substrate first and then the shielding structure can be provided to overlap with the antenna structure. Alternatively, the shielding structure can be provided on the substrate first and then the antenna structure can be provided to overlap with the shielding structure.

In the above-described package and method, the substrate can have a plurality of circuits electrically connected to the electronic element.

In the above-described package and method, the electronic element can be an active element or a passive element.

In the above-described package and method, the antenna structure can be a metal frame.

In the above-described package and method, the extending portion can be an antenna body.

In the above-described package and method, the extending portion can have a bent shape, a ring shape or a ring shape having an opening.

In the above-described package and method, the extending portion can be higher in position than the electronic element.

In the above-described package and method, the extending portion can be electrically connected to the substrate through the supporting portion.

In the above-described package and method, the shielding structure can be not in contact with the antenna structure.

In the above-described package and method, the shielding structure can be a metal layer, a metal frame or a metal cover.

In the above-described package and method, an encapsulant can be formed on the substrate for encapsulating the electronic element and the extending portion and the supporting portion of the antenna structure. In an embodiment, the antenna structure is provided on the substrate first, and then the encapsulant is formed, and thereafter the shielding structure is provided on the encapsulant. In another embodiment, the antenna structure is provided on the substrate first, and then the shielding structure is provided to overlap with the antenna structure, and thereafter the encapsulant is formed to encapsulate the shielding structure. In a further embodiment, the shielding structure is provided on the substrate first, and then the antenna structure is provided to overlap with the shielding structure, and thereafter the encapsulant is formed to encapsulate the shielding structure.

According to the present invention, since the extending portion is supported over the substrate and surrounds the electronic element, both the extending portion and the electronic element can be encapsulated by the encapsulant. As such, the present invention can use a mold having a size corresponding to the substrate so as to facilitate the molding process for forming the encapsulant.

Further, since the extending portion is supported over an area of the substrate where the electronic element is disposed (i.e., where the encapsulant is to be formed), the invention saves the surface area of the substrate, thereby effectively reducing the size of the substrate and meeting the miniaturization requirement of the electronic package.

Furthermore, the shielding structure and the antenna structure overlap with one another so as to protect the antenna structure against external electromagnetic interferences and meet the miniaturization requirement.

### BRIEF DESCRIPTION OF DRAWINGS

FIG. 1 is a schematic perspective view of a conventional wireless communication module;

FIGS. 2A to 2C are schematic perspective views showing a method for fabricating an electronic package according to a first embodiment of the present invention, wherein FIG. 2A′ shows another embodiment of FIG. 2A, and FIG. 2C′ shows another embodiment of FIG. 2C; and

FIGS. 3A to 3D are schematic perspective views showing a method for fabricating an electronic package according to a second embodiment of the present invention, wherein FIG. 3C′ shows another embodiment of FIG. 3C.

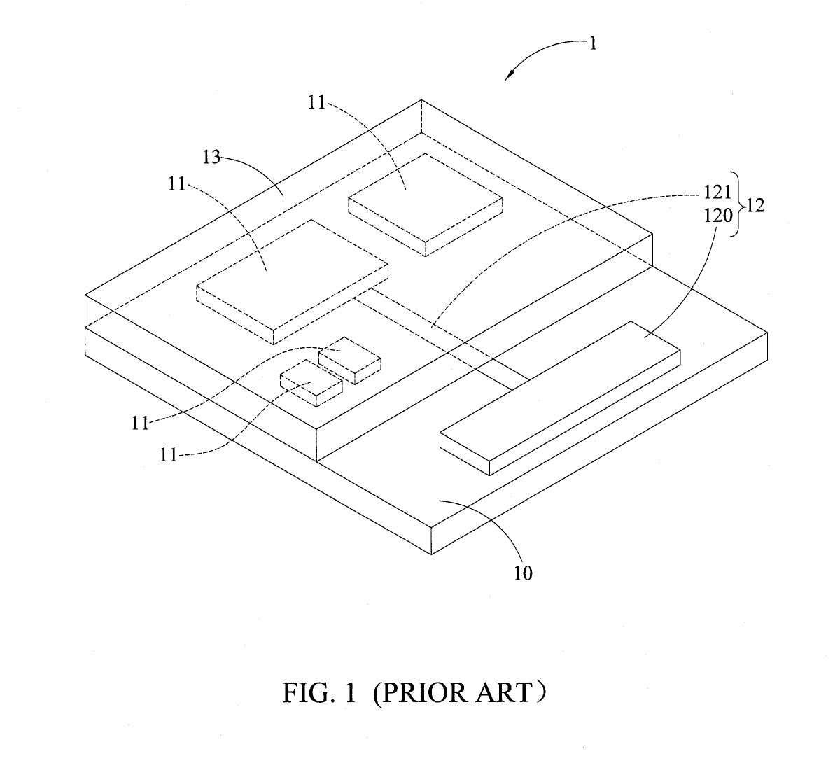

### DETAILED DESCRIPTION OF PREFERRED EMBODIMENTS

The following illustrative embodiments are provided to illustrate the disclosure of the present invention, these and other advantages and effects can be apparent to those in the art after reading this specification.

It should be noted that all the drawings are not intended to limit the present invention. Various modifications and variations can be made without departing from the spirit of the present invention. Further, terms such as “first”, “second”, “on”, “a” etc. are merely for illustrative purposes and should not be construed to limit the scope of the present invention.

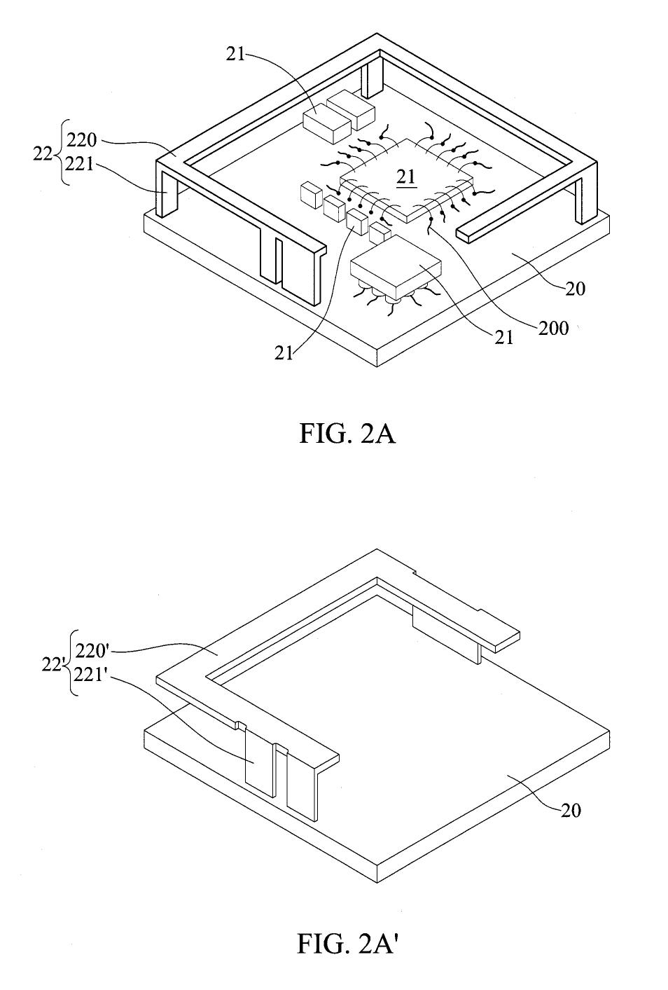

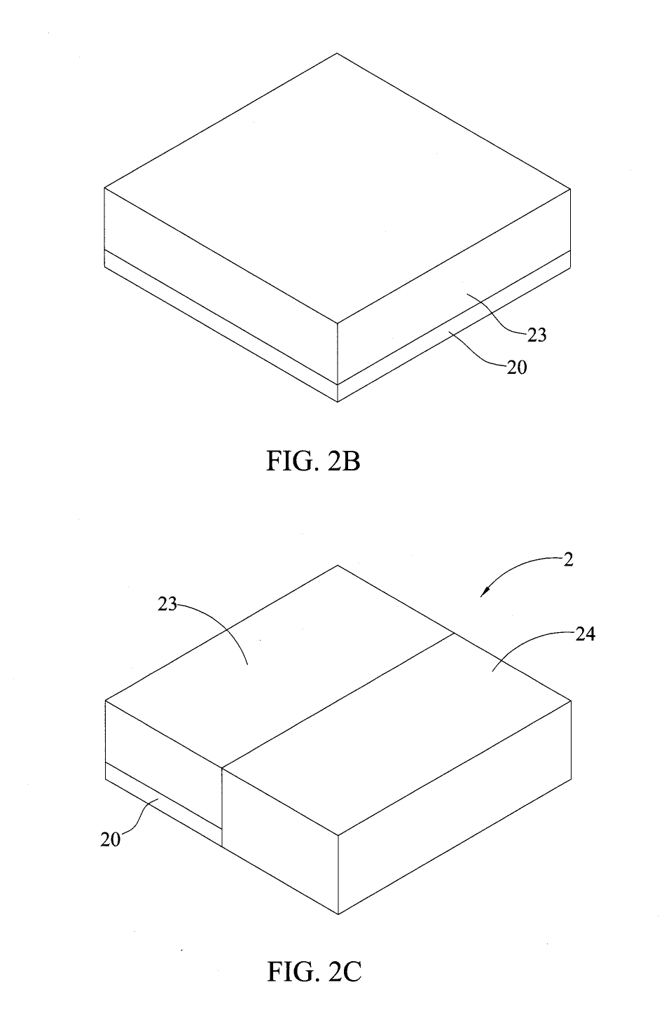

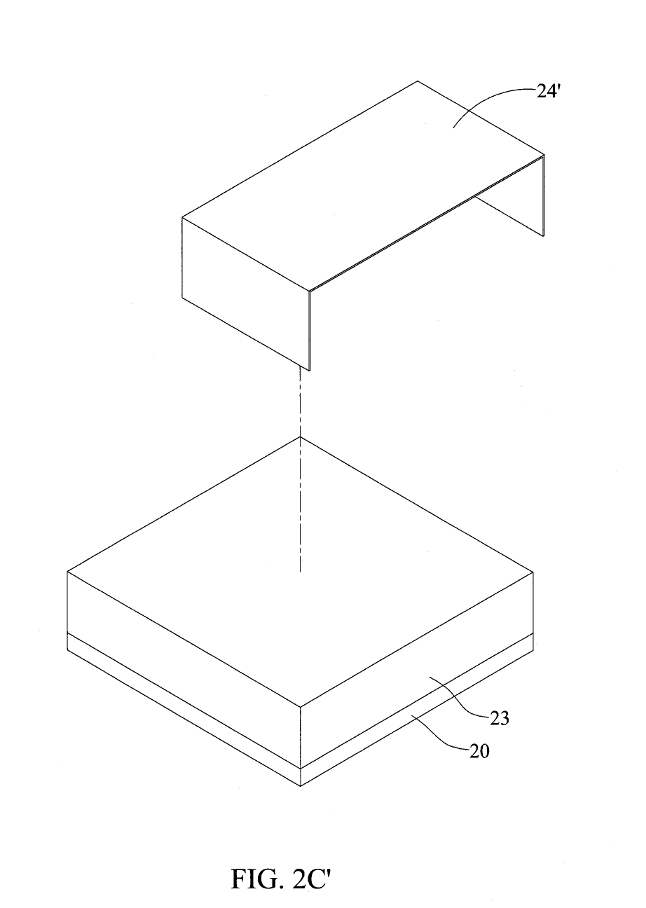

FIGS. 2A to 2C are schematic perspective views showing a method for fabricating an electronic package 2 according to a first embodiment of the present invention. In the present embodiment, the electronic package 2 is a SiP (system in package) wireless communication module.

Referring to FIG. 2A, a substrate 20 is provided. The substrate 20 has a plurality of electronic elements 21 disposed thereon. Then, an antenna structure 22 is disposed on and electrically connected to the substrate 20.

In the present embodiment, the substrate 20 is a circuit board or a ceramic board and has a rectangular shape. A plurality of circuits 200 are formed on a surface of the substrate 20. Further, one or more circuit layers (not shown) can be formed inside the substrate 20.

The electronic elements 21 can be active or passive elements. The electronic elements 21 are electrically connected to the circuits 200.

The antenna structure 22 is a metal frame. The antenna structure 22 has an extending portion 220, and a supporting portion 221 vertically disposed on the substrate 20 for supporting the extending portion 220 over the substrate 20. As such, the extending portion 220 of the antenna structure 22 is located at a position higher than the electronic elements 21 and correspondingly extends along side edges of substrate 20 to surround the electronic elements 21. The extending portion 220 serves as an antenna body. The extending portion 220 can have a ring shape having an opening. For example, the extending portion 220 has a substantially C-shape, as shown in FIG. 2A, or a substantially n-shape, as shown in FIG. 2A′. In other embodiments, the extending portion 220 can have a bent shape, such as an L-shape, or a ring shape, such as a rectangular shape.

Further, according to the practical need, a plurality of supporting portions 221 can be provided to serve as input and ground terminals for electrically connecting the extending portion 220 to the circuits 200. In addition, the electronic elements 21 can be electrically connected to the extending portion 220 through at least a bonding wire (not shown).

Referring to FIG. 2B, an encapsulant 23 is formed on the substrate 20 to encapsulate the electronic elements 21 and the extending portion 220 and the supporting portion 221 of the antenna structure 22.

Referring to FIG. 2C, a shielding structure 24 is formed on the encapsulant 23 to cover portions of surfaces of the encapsulant 23 and portions of side surfaces of the substrate 20. As such, the shielding structure 24 and the antenna structure 22 overlap with one another and the encapsulant 23 is sandwiched between the shielding structure 24 and the antenna structure 22.

In the present embodiment, the antenna structure 22 is provided first and then the shielding structure 24 is provided to overlap with the antenna structure 22.

In the present embodiment, the shielding structure 24 is a metal layer formed by coating. The shielding structure 24 covers about one-half or one-third of the surfaces of the encapsulant 23 and portions of the side surfaces of the substrate 20. In another embodiment, referring to FIG. 2C′, the shielding structure 24′ is a metal frame that covers portions of the surfaces of the encapsulant 23 and portions of the side surfaces of the substrate 20.

Further, the shielding structure 24, 24′ can be provided corresponding to the profile of the encapsulant 23 so as to minimize the size of the electronic package 2.

The shielding structure 24, 24′ protects the antenna structure against external electromagnetic interferences.

According to the present invention, a metal sheet is formed into the 3D antenna structure 22 and then the extending portion 220 of the antenna structure 22 is disposed over the substrate 20 to surround the electronic elements 21. As such, the extending portion 220 and the electronic elements 21 can be integrally fabricated. That is, both the extending portion 220 and the electronic elements 21 can be encapsulated by the encapsulant 23. Therefore, the present invention can use a mold having a size corresponding to the substrate 20 so as to facilitate the molding process for forming the encapsulant 23.

Further, the extending portion 220 can be stably fixed at a certain height by the encapsulant 23. Furthermore, the dielectric constant of the encapsulant 23 facilitates to reduce the required electrical length of the antenna structure.

Moreover, since the extending portion 220 is supported over an area of the substrate 20 where the electronic elements 21 are disposed (i.e., the area where the encapsulant 23 is to be formed) instead of being directly disposed on the surface of the substrate 20 as in the prior art, the present invention saves the surface area of the substrate 20. Therefore, compared with the prior art, the present invention can effectively reduce the size of the substrate 20 so as to meet the miniaturization requirement of the electronic package 2.

Also, by disposing the extending portion 220 over the substrate 20, a receiving space is formed between the extending portion 220 and the substrate 20 for receiving other electrical structures.

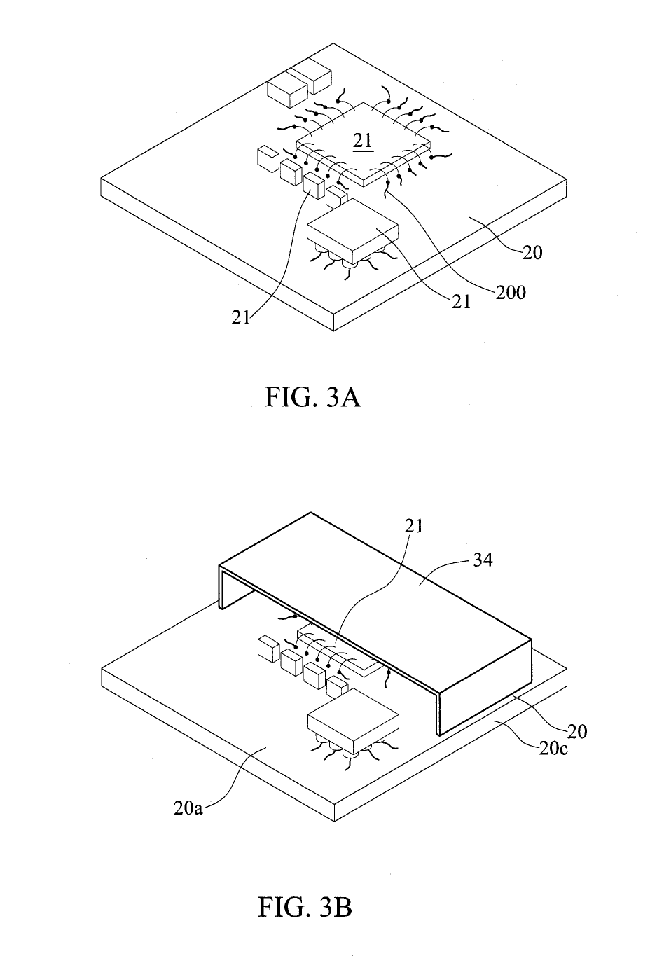

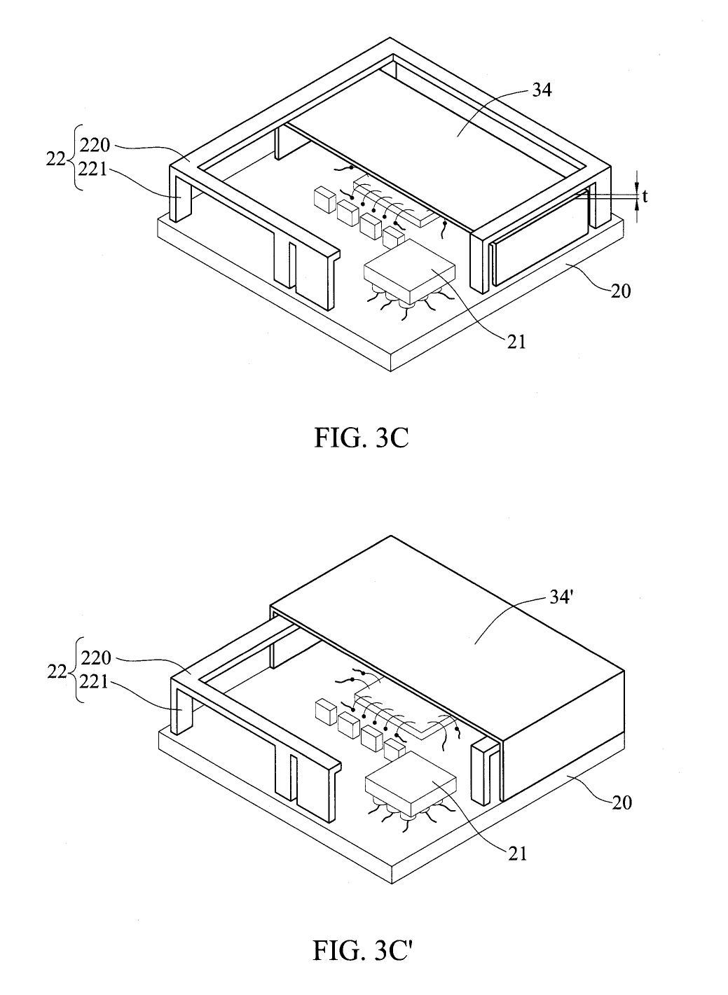

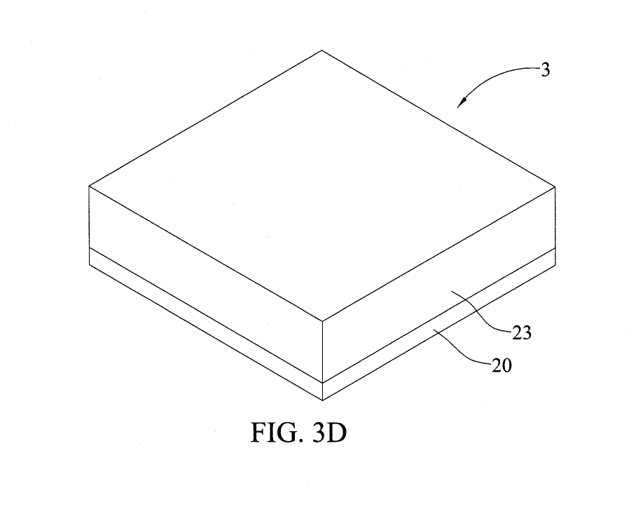

FIGS. 3A to 3D are schematic perspective views showing a method for fabricating an electronic package 3 according to a second embodiment of the present invention.

Referring to FIG. 3A, a substrate 20 having a plurality of electronic elements 21 disposed thereon is provided.

Referring to FIG. 3B, a shielding structure 34 is disposed on the substrate 20 to cover a portion of the surface of the substrate 20 and portions of the electronic elements 21.

In the present embodiment, the shielding structure 34 is a metal cover. The shielding structure 34 is positioned inside the top surface 20a of the substrate 20 without protruding from the side surfaces 20c of the substrate 20 so as to minimize the size of the package.

Referring to FIG. 3C, an antenna structure 22 is disposed on and electrically connected to the substrate 20.

In the present embodiment, the shielding structure 34 is disposed on the substrate 20 first and then the antenna structure 22 is disposed to overlap with the shielding structure 34.

In particular, a gap t is formed between the antenna structure 22 and the shielding structure 34. As such, the antenna structure 22 does not contact with the shielding structure 34.

In another embodiment, referring to FIG. 3C′, the shielding structure 34′ is higher than the antenna structure 22. A gap is formed between the shielding structure 34′ and the antenna structure 22. As such, the antenna structure 22 does not contact with the shielding structure 34′.

Referring to FIG. 3D, an encapsulant 23 is formed on the substrate 20 for encapsulating the shielding structure 34, the electronic elements 21 and the antenna structure 22.

In the present embodiment, the encapsulant 23 is formed between the shielding structure 34 and the antenna structure 22.

The invention further provides an electronic package 2, 3, which has: a substrate 20, at least an electronic element 21 disposed on the substrate 20, an antenna structure 22, 22′ provided on the substrate 20, and a shielding structure 24, 24′, 34, 34′ provided on the substrate 20 and overlapping with the antenna structure 22, 22′.

The substrate 20 can have a plurality of circuits 200.

The electronic element 21 can be an active element or a passive element and electrically connected to the circuits 200.

The antenna structure 22, 22′ has at least a supporting portion 221, 221′ vertically disposed on the substrate 20 and an extending portion 220, 220′ supported by the supporting portion 221, 221′ over the substrate 20 and surrounding the electronic element 21. The antenna structure 22, 22′ can be a metal frame. The extending portion 220, 220′ can serve as an antenna body.

The extending portion 220, 220′ can be higher in position than the electronic element 21. The extending portion 220, 220′ can have a bent shape, a ring shape, or a ring shape having an opening.

The supporting portion 221, 221′ can serve as input and ground terminals for electrically connecting the extending portion 220, 220′ to the circuits 200 or inner circuit layers of the substrate 20.

In the present embodiment, the shielding structure 24, 24′, 34, 34′ and the antenna structure 22, 22′ overlaps with one another, but does not contact with one another. The shielding structure 24, 24′, 34, 34′ can be a metal layer, a metal frame or a metal cover.

The electronic package 2 can further comprise an encapsulant 23 formed on the substrate 20 for encapsulating the electronic element 21 and the extending portion 220, 220′ and the supporting portion 221, 221′ of the antenna structure 22, 22′.

In an embodiment, the shielding structure 24, 24′ covers the encapsulant 23. In another embodiment, the encapsulant 23 encapsulates the shielding structure 34, 34′.

According to the present invention, a 3D antenna structure is provided to replace the conventional planar antenna structure. Since the 3D antenna structure can be supported over an area of the substrate where the electronic element is disposed (i.e., where the encapsulant is to be formed), the invention not only facilitates the molding process but also reduces the size of the substrate to thereby meet the miniaturization requirement of the electronic package.

Furthermore, the shielding structure and the antenna structure overlap with one another so as to protect the antenna structure against external electromagnetic interferences and meet the miniaturization requirement.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. An electronic package, comprising:
a substrate;
at least an electronic element disposed on the substrate;
an antenna structure provided on the substrate, wherein the antenna structure has at least a supporting portion and an extending portion supported by the supporting portion over the substrate and surrounding the electronic element; and
a shielding structure provided on the substrate and overlapping with the antenna structure.

2. The package of claim 1, wherein the substrate has a plurality of circuits electrically connected to the electronic element.

3. The package of claim 1, wherein the electronic element is an active element or a passive element.

4. The package of claim 1, wherein the antenna structure is a metal frame.

5. The package of claim 1, wherein the extending portion is an antenna body.

6. The package of claim 1, wherein the extending portion has a bent shape, a ring shape or a ring shape having an opening.

7. The package of claim 1, wherein the extending portion is higher in position than the electronic element.

8. The package of claim 1, wherein the extending portion is electrically connected to the substrate through the supporting portion.

9. The package of claim 1, wherein the shielding structure does not contact with the antenna structure.

10. The package of claim 1, wherein the shielding structure is a metal layer, a metal frame or a metal cover.

11. The package of claim 1, further comprising an encapsulant formed on the substrate for encapsulating the electronic element and the extending portion and the supporting portion of the antenna structure.

12. The package of claim 11, wherein the shielding structure covers the encapsulant.

13. The package of claim 11, wherein the encapsulant encapsulates the shielding structure.

14. A method for fabricating an electronic package, comprising the steps of:
providing a substrate having at least an electronic element disposed thereon; and
providing an antenna structure and a shielding structure on the substrate such that the shielding structure overlaps with the antenna structure, wherein the antenna structure has at least a supporting portion and an extending portion supported by the supporting portion over the substrate and surrounding the electronic element.

15. The method of claim 14, wherein the substrate has a plurality of circuits electrically connected to the electronic element.

16. The method of claim 14, wherein the electronic element is an active element or a passive element.

17. The method of claim 14, wherein the antenna structure is a metal frame.

18. The method of claim 14, wherein the extending portion is an antenna body.

19. The method of claim 14, wherein the extending portion has a bent shape, a ring shape or a ring shape having an opening.

20. The method of claim 14, wherein the extending portion is higher in position than the electronic element.

21. The method of claim 14, wherein the extending portion is electrically connected to the substrate through the supporting portion.

22. The method of claim 14, wherein the shielding structure does not contact with the antenna structure.

23. The method of claim 14, wherein the shielding structure is a metal layer, a metal frame or a metal cover.

24. The method of claim 14, wherein the antenna structure is provided on the substrate first and then the shielding structure is provided to overlap with the antenna structure.

25. The method of claim 14, wherein the shielding structure is provided on the substrate first and then the antenna structure is provided to overlap with the shielding structure.

26. The method of claim 14, further comprising forming an encapsulant on the substrate for encapsulating the electronic element and the antenna structure.

27. The method of claim 26, wherein the antenna structure is provided on the substrate first, and then the encapsulant is formed, and thereafter the shielding structure is provided on the encapsulant.

28. The method of claim 26, wherein the antenna structure is provided on the substrate first, and then the shielding structure is provided to overlap with the antenna structure, and thereafter the encapsulant is formed to encapsulate the shielding structure.

29. The method of claim 26, wherein the shielding structure is provided on the substrate first, and then the antenna structure is provided to overlap with the shielding structure, and thereafter the encapsulant is formed to encapsulate the shielding structure.
